(19) United States
(12) Patent Application Publication
(10) Pub. No.: US 2023/0049070 A1
(43) Pub. Date: Feb. 16, 2023

(54) Dissolvable Toilet Brush Formulations

(71) Applicant: Henkel IP & Holding GmbH, Duesseldorf (DE)

(72) Inventors: Daniel Thomas Piorkowski, Fairfield, CT (US); Dylan Robbins, Stamford, CT (US); Jonathan Domingues Afonso, Mountainside, NJ (US); Rodrigo Mena-Brito, New Providence, NJ (US)

(21) Appl. No.: 17/444,025

(22) Filed: Jul. 29, 2021

(51) Int. Cl. C11D 1/37; C11D 11/00; C11D 3/10; C11D 3/12; C11D 3/20; C11D 3/32; C11D 17/00; C11D 17/04

(52) U.S. Cl. CPC C11D 1/37; C11D 11/0052; C11D 3/10; C11D 3/126; C11D 3/2082; C11D 3/2086; C11D 3/32; C11D 17/0056; C11D 17/041; C11D 1/146

(57) ABSTRACT

Formulations for dissolvable solid unit dose toilet cleaning compositions containing an anionic surfactant, a carbonate or bicarbonate salt, a water-soluble filler and an organic acid, wherein the ratio of anionic surfactant to filler is 1:6 to 5:1. The filler includes clay, a sugar or a salt. The solid unit dose can be a tablet or compressed solid that engages with a wand to clean a toilet. The solids dissolve and can be flushed after use.

### FIELD OF THE INVENTION

The present invention is in the field of household and industrial cleaning in applications for cleaning toilets. The present invention relates to dissolvable unit dose formulations that can be used with a wand for manually cleaning toilets.

### BACKGROUND OF THE INVENTION

Toilet brushes are typically used to swirl cleaning chemicals around a toilet bowl and then to scrub the sides of the bowl with those chemicals and water, so as to assist in removing stains along the bowl sides. After using such brushes, a consumer will typically attempt to rinse off the brush by swirling it in the bowl water. However, cleaning chemicals, feces, urine, and stray bits of paper typically found in the toilet can be retained on the brush or in its holder.

Numerous mechanical devices have been proposed to overcome disadvantages of a toilet brush having a permanently affixed head. Several commercially available products include a removable head that must be thrown away in the trash. For instance, U.S. Patent Application Publication no. 2016/0106274 discloses a non-woven cleaning fabric layer comprising a cleaning composition, and a functional non-woven fabric layer comprising a functional composition. The cleaning composition comprises an anionic surfactant, an ethanolamine-based compound, a pigment, a dye, or a mixture thereof, and a solvent. The functional composition comprises a functional polymer and one or more surfactant.

GB 738,299 discloses a toilet cleaning device where the head is slipped into a swab and a toilet is then cleaned by wiping the swab around the surface of the bowl of the toilet. Removal of the swab is achieved by shouldering the swab against the rim of a toilet bowl and pulling the holder away to cause the swab to slip off, into the bowl, and dissolve prior to being flushed away. Other flushable and replaceable brush head elements are disclosed in e.g. U.S. Pat. Nos. 2,755,497, 4,031,673, 5,630,243, and 6,094,771 and GB 2,329,325.

U.S. Pat. No. 7,650,663 discloses flushable heads that are insertable in a permanent type wand. The brush head may be a stack of sheets of water-dissolvable material. The sheets are compressed to bind them together into a stack. Surface indentations and piercing of layers at the indentations are used to bind the brush head layers together securely without the need for binding adhesives, and to facilitate clamping. The heads releasable from the wand and are said to break up and behave like toilet paper, so they are flushable after use.

However, flushable heads, such as those disclosed in U.S. Pat. No. 7,650,663 are water degradable, as opposed to dissolvable. Thus, oftentimes consumers will opt to discard these heads in their garbage for fear of clogging their toilets as flushable heads take longer to break up and/or have the tendency to degrade incompletely.

Water solubility (as opposed to degradability) is a desirable feature for a toilet cleaning “brush” because it allows the head to be flushed immediately after use, thereby avoiding the need to transport the dripping head to a garbage can, and avoiding any odors that may develop if the brush head were left in a garbage can for some time period after use. It also avoids the potential for clogging that can occur when ingredients of a pad dissolve incompletely and/or take a long time to break up.

U.S. Pat. No. 5,471,697 discloses a toilet cleaning device that has a cleaning head in the shape of a foot. This head is able to clean underneath the rim of the toilet. However, a user has to continually rotate the device as they clean underneath the rim which involves two hands. This is inconvenient and it also causes one of the hands to be closer to the bowl which may have germs. The disposable feet are made from enzyme-coated biodegradable polymer particles, acrylic polymers, vinyl polymers or copolymers containing acid groups, sodium propionate or polyethylene glycol, thus they are expensive and may take considerable time to dissolve. Furthermore, in order to remove the head from the shaft, the shaft has to be left in the toilet bowl while the head dissolves. This renders the toilet unusable during that period.

WO 2014/039356A1 discloses dissolvable unit doses with an applicator for cleaning toilets but provides no details on a suitable cleaning formulation for the dissolvable unit dose.

There is a need for improved toilet “brush” head formulations. In particular, there is a need for solid unit dose cleaning compositions that can be attached to a wand apparatus to mechanically clean a toilet bowl surface and that are dissolvable in toilet water after they are used to clean the bowl.

### SUMMARY OF THE INVENTION

The present invention provides dissolvable solid unit dose formulations e.g., compressed tablets, that can be used with a wand apparatus to clean a toilet surface. The unit doses can be removably attached to the cleaning wand. The dissolvable formulations alleviate fear of flushing solid material and enables the consumer to clean the toilet and then see the solid dissolve during/after use. The formulations include ratios of surfactants, acids (for biocidal effects) and filler (i.e. salt, sugar or clay) that enable a product that has a good dissolution rate, structural integrity (so it does not crack during shipment or while in use), provides foaming (an indication of cleaning efficacy), and is resistant to significant humidity abuse.

In one aspect, the invention provides a solid unit dose toilet cleaning composition comprising an anionic surfactant, a carbonate or bicarbonate salt, a water-soluble filler comprising a clay, a sugar, or a salt; and an organic acid, wherein the ratio of anionic surfactant to filler is 1:6 to 5:1.

In certain embodiments, the ratio of surfactant to filler is about 1:4 to about 4:1.

In certain embodiments, the ratio of surfactant to filler is about 1:1.5 to about 1:4, most preferably about 1:1.5.

In some embodiments, the cleaning composition comprises about 10% to about 80% by weight filler.

In certain embodiments, the water-soluble filler is about 40% to about 70% by weight of the cleaning composition.

In some embodiments, the filler comprises bentonite clay. In some of those embodiments, the filler consists essentially of bentonite clay. In some embodiments, the filler consists of bentonite clay.

In certain embodiments, the filler consists essentially of a sugar. In some embodiments, the filler consists of a sugar.

In certain embodiments, the filler consists essentially of a salt. In some embodiments, the filler consists of a salt.

In some embodiments, the anionic surfactant is selected from Sodium Dodecylbenzenesulfonate, Sodium Cocoyl Isethionate, Sodium Olefin Sulphonate, and combinations thereof.

In certain embodiments, the cleaning composition comprises about 5% to about 50% by weight anionic surfactant, more preferably about 7% to about 20% by weight of the cleaning composition.

In certain embodiments, the organic acid comprises about 1% to about 30% by weight of the cleaning composition.

In some of those embodiments, the cleaning composition comprises about 1% to about 7% by weight of acid. In other of those embodiments, the cleaning composition comprises about 5% to about 30% of acid.

In some embodiments, the organic acid consists of glycolic acid or citric acid.

In certain embodiments, the cleaning composition comprises about 5-20% by weight of a carbonate or bicarbonate salt.

In certain embodiments, the unit dose is a compressed solid.

In some embodiments, the unit dose has a dissolution rate of at least about 0.1 g/min minute when submerged in water without agitation.

In certain embodiments, the unit dose weighs about 1 to about 70 grams, more preferably about 10 to about 50 grams, most preferably about 20 to about 40 grams.

In some embodiments, at least 12% by weight of the solid unit dose dissolves after 5 minutes submerged in water.

In another aspect, the invention provides a dissolvable toilet cleaning tablet comprising an anionic surfactant, a carbonate or bicarbonate salt, filler, and an organic acid, wherein the tablet has a dissolution rate of at least about 0.1 g/minute when submerged in water without agitation.

In some embodiments, the ratio of anionic surfactant to filler is 1:6 to 5:1.

In certain embodiments, the ratio of surfactant to filler is about 1:4 to about 4:1.

In certain embodiments, the ratio of surfactant to filler is about 1:1.5 to about 1:4, most preferably about 1:1.5.

In some embodiments, the tablet has a top surface, a bottom surface, and a height spanning from the top surface to the bottom surface, the top surface having an indentation adapted to receive a wand member and having a depth that is less than the height.

In some embodiments, the tablet has a hardness of at least 15 N, more preferably at least 20 N, most preferably at least 30 N. In preferred embodiments, the tablet has a hardness greater than 30 N.

In certain embodiments, the tablet has height of about 0.5 cm to about 10 cm. In some embodiments, the tablet has a height of about 0.8 cm to about 1 cm. In other embodiments, the tablet has a height of about 5 to about 10 cm.

In certain embodiments, the compressed solid has a diameter and a height to diameter ratio of the compressed solid is greater than 2:1.

In certain embodiments, at least 12% by weight of the tablet dissolves after 5 minutes submerged in water. In some of those embodiments, at least about 20% by weight of the tablet dissolves after 5 minutes submerged in water.

In some embodiments, at least 12% of the tablet dissolves after 1 minute submerged in water. In some of those embodiments, at least about 20% by weight of the tablet dissolves after 1 minute submerged in water.

In a third aspect, the invention provides a kit comprising at least one dissolvable toilet cleaning solid unit dose or tablet and a wand member. The wand member is releasably attached to the solid cleaning composition and is used to mechanically clean a toilet with the cleaning composition.

In a fourth aspect, the invention provides a dissolvable toilet cleaning composition comprising about 5% to about 50% by weight anionic surfactant, about 10% to about 80% by weight filler selected from clay, sugars, and water-soluble salts, about 5-20% by weight of a carbonate or bicarbonate salt; and about 1% to about 30% by weight of an organic acid, wherein at least 12% by weight of the tablet dissolves after 5 minutes submerged in water.

In some embodiments, the ratio of anionic surfactant to filler is 1:6 to 5:1. In certain embodiments, the ratio of surfactant to filler is about 1:4 to about 4:1. In certain embodiments, the ratio of surfactant to filler is about 1:1.5 to about 1:4, most preferably about 1:1.5.

In certain embodiments, the filler is about 40% to about 70% by weight of the cleaning composition.

In some embodiments, the filler comprises bentonite clay. In some of those embodiments, the filler consists essentially of bentonite clay. In some embodiments, the filler consists of bentonite clay.

In certain embodiments, the filler consists essentially of a sugar. In some embodiments, the filler consists of a sugar.

In certain embodiments, the filler consists essentially of a salt. In some embodiments, the filler consists of a salt.

In some embodiments, the anionic surfactant is selected from Sodium Dodecylbenzenesulfonate, Sodium Cocoyl Isethionate, Sodium Olefin Sulphonate, and combinations thereof.

In certain embodiments, the cleaning composition comprises about 7% to about 20% by weight of anionic surfactant.

In some embodiments, the cleaning composition comprises about 1% to about 7% by weight of acid. In other embodiments, the cleaning composition comprises about 5% to about 30% of acid.

In some embodiments, the organic acid consists of glycolic acid or citric acid.

In certain embodiments, the solid weighs about 1 to about 70 grams, more preferably about 10 to about 50 grams, most preferably 20 to about 40 grams. In certain of those embodiments, the solid weighs about 2.25 to 2.5 g.

In certain embodiments, the dissolvable composition is a compressed solid. In certain of those embodiments, the dissolvable composition is a tablet.

In certain embodiments, the compressed solid has height of about 0.5 cm to about 10 cm. In some embodiments, the compressed solid has a height of about 0.8 cm to about 1 cm. In other embodiments, the compressed solid has a height of about 5 to about 10 cm.

In certain embodiments, the compressed solid has a diameter and a height to diameter ratio of the compressed solid is greater than 2:1.

In some embodiments, the dissolvable composition has a dissolution rate of at least about 0.1 g/min minute when submerged in water without agitation.

### BRIEF DESCRIPTION OF THE DRAWINGS

FIG. 1 is a photograph illustrating a device for cleaning toilets having an exemplary unit dose toilet cleaning composition of the present invention and a wand that can be releasably attached to the unit dose.

FIG. 2 is a perspective view of the unit dose of FIG. 1.

### DETAILED DESCRIPTION OF THE INVENTION

The following detailed description is merely exemplary in nature and is not intended to limit the compositions or the methods for producing or using the same. Furthermore, there is no intention to be bound by any theory presented in the preceding background or the following detailed description.

Except in the operating and comparative examples, or where otherwise explicitly indicated, all numbers in this description indicating amounts or ratios of material or conditions of reaction, physical properties of materials and/or use are to be understood as modified by the word “about”.

The term “about” as used in connection with a numerical value throughout the specification and the claims denotes an interval of accuracy, familiar and acceptable to a person skilled in the art. In general, such interval of accuracy is +−10%. Thus, “about ten” means 9 to 11. All numbers in this description indicating amounts, ratios of materials, physical properties of materials, and/or use are to be understood as modified by the word “about,” except as otherwise explicitly indicated.

Weight percent, percent by weight, wt %, wt-%, % by weight, and the like are synonyms that refer to the concentration of a substance as the weight of that substance divided by the weight of the composition and multiplied by 100. As used in this application, the term “wt. %” refers to the weight percent of the indicated component relative to the total weight of the solid detergent composition, unless indicated differently. The weight percentage of an individual component does not include any water supplied with that component, even if the component is supplied as an aqueous solution or in a liquid premix, unless otherwise specified.

The recitation of numerical ranges by endpoints includes all numbers within that range (e.g. 1 to 5 includes 1, 1.5, 2, 2.75, 3, 3.80, 4, and 5).

Provided herein are dissolvable solid unit dose toilet cleaning compositions, which are typically produced in the form of compressed solids or tablets comprising several components: an anionic surfactant, a carbonate or bicarbonate salt, a water-soluble filler, and an organic acid. The solid products can be used with a releasably connected wand or handle as a toilet brush.

“Cleaning” means to perform or aid in soil removal, bleaching, microbial population reduction, or combination thereof.

As used herein, the term “comprising” means including, made up of, composed, characterized by, or having.

As used herein, the term “brush” means an implement with a handle and including of a solid member at one end that can be used for cleaning, scrubbing, applying a liquid or powder to a surface. The solid member of the brush may be referred to as a “head.”

As used herein, a “solid cleaning composition” refers to a cleaning composition in the form of a solid for example, a granule, a pellet, a tablet, a lozenge, a puck, a briquette, a brick, a solid block, or a unit dose. The term “solid” refers to the state of the detergent composition under the expected conditions of storage and use of the solid detergent composition. In general, it is expected that the cleaning composition will remain in solid form when exposed to temperatures of up to about 100° F. and greater than about 120° F.

A “stable solid” composition refers to a solid that retains its shape under conditions in which the composition may be stored or handled.

A solid unit dose refers to a cleaning composition unit sized so that the entire unit is used during a single cleaning cycle. When the solid cleaning composition is provided as a unit dose, it is preferably provided as a compressed solid, such as a tablet having a size of between about 1 gram and about 50 grams. Furthermore, it should be appreciated that the solid cleaning composition can be provided so that a plurality of the solids will be available in a package having a size of between about 40 grams and about 1,000 grams.

The solid head may be in various compressed, cast, or extruded forms including, for example, pellets, blocks, and tablets, but not powders.

The present invention also provides methods of production of such compositions, and methods of use of such compositions in processes for cleaning toilets by introducing one of the unit dose products into a toilet bowl, whereby the cleaning system is released such that it comes into contact with a soiled toilet bowl under conditions for the removal of one or more soils from the toilet bowl. The unit doses dissolve in toilet water after they are used to clean the bowl.

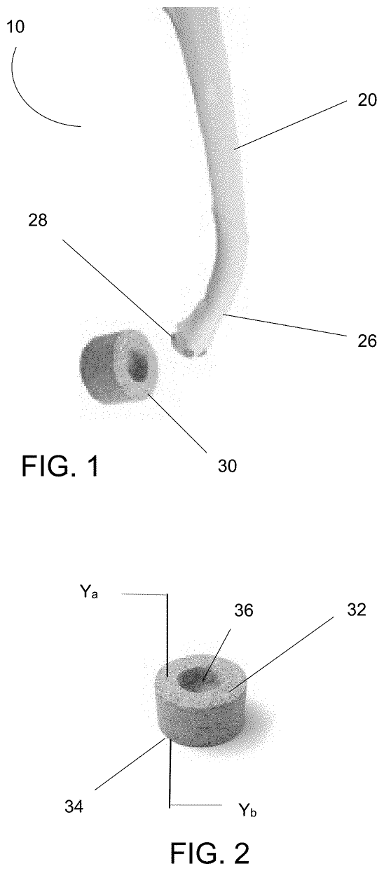

An exemplary solid unit dose composition of the present invention is shown in FIGS. 1 and 2. As shown, a device for cleaning toilets 10 comprises a wand 20 and a unit dose cleaning head 30. Wand 20 has a proximal end with a hand grip for grasping by the user's hand and a distal end 26 with a pin 28 extending from the distal end 26. The unit dose head 30 contains a cleaning composition comprised of powders that have been compressed into a tablet.

As shown in FIG. 2, the head 30 contains a top surface 32, a bottom surface 34, and a height Ya-Yb extending from the top surface to the bottom surface. An indentation, specifically, a cylindrical socket 36 is contained in the top surface and is adapted to receive and frictionally engage with pin 28 of wand 20. A depth Yc-Yd of the cylindrical socket 36 is less than the height Ya-Yb.

Cleaning head 30 is shown as substantially cylindrical and having a diameter but it may take other shapes.

The solid head 30 may be in various forms including, for example, pellets, blocks, and tablets, but not powders.

In certain embodiments, the solid unit dose cleaning head 30 weighs about 1 to about 70 grams, more preferably about 10 to about 50 grams, most preferably about 20 to about 40 grams.

In certain embodiments, the solid unit dose cleaning head has height of about 0.5 cm to about 10 cm. In some embodiments, the tablet has a height of about 0.8 cm to about 1 cm. In other embodiments, the tablet has a height of about 5 to about 10 cm.

In certain embodiments, the solid unit dose cleaning head has a diameter and a height to diameter ratio of the compressed solid is greater than 2:1.

In some embodiments, the solid unit dose cleaning head is a tablet having a hardness of at least 15 N, more preferably at least 20 N, most preferably at least 30 N. In preferred embodiments, the tablet has a hardness greater than 30 N.

The solid cleaning composition contains one or more chemical constituents e.g., coloring agents, cleaning agents, disinfecting agents, fragrance in the form of a head. The cleaning activity is formed by water contacting the head of the device coming into contact with the one or more chemical constituents.

In preferred embodiments, the cleaning composition provides cleaning efficacy, a foaming visual cue, fragrance sensorial experience and slowly dissolves so one does not have to re-store or throw away the cleaning head portion of the product. The toilet cleaning head is advantageously dissolvable, which negates the need for the consumer to store an unpleasant, bacteria filled cleaning tool.

### Cleaning Composition

Surfactant

The toilet cleaning composition comprises one or more surfactants, of which one or more is anionic, and the additional surfactants may be cationic and/or non-ionic and/or semi-polar and/or zwitterionic, or a mixture thereof. In a particular embodiment, the cleaning composition includes a mixture one or more anionic surfactants with one or more non-ionic surfactants. The total active surfactant(s) is typically present at a level of from about 5% to 40% by weight, such as about 7% to about 35%, based on total weight of the cleaning composition. The surfactant(s) is chosen based on the desired cleaning application, and may include any conventional surfactant(s) known in the art.

Anionic surfactants are useful in the context of this invention to both improve the cleaning properties of the compositions. The anionic surfactants used in this invention can be any anionic surfactant that is substantially water soluble. “Water soluble” surfactants are, unless otherwise noted, here defined to include surfactants which are soluble or dispersible to at least the extent of 0.01% by weight in distilled water at 25° C. “Anionic surfactants” are defined herein as amphiphilic molecules with an average molecular weight of less than about 10,000, comprising one or more functional groups that exhibit a net anionic charge when in aqueous solution at pH of between 6 and 11.

Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (IVIES), alkyl- or alkenylsuccinic acid, dodecenyl/tetradecenyl succinic acid (DTSA), fatty acid derivatives of amino acids, diesters and monoesters of sulfo-succinic acid or salt of fatty acids (soap), and combinations thereof.

The anionic surfactant may be, for example, Sodium Xylene Sulphonate, Sodium Dodecylbenzenesulfonate, Sodium C14-C16 Alpha Olefin Sulfonate, Sodium Cocosulfate, Sodium Lauryl Sulfate, Sodium Cocoyl Isethionate, Sodium Olefin Sulphonate.

In some preferred embodiments, the anionic surfactant is a LAS.

In certain preferred embodiments, the anionic surfactant is selected from Sodium Dodecylbenzenesulfonate, Sodium Cocoyl Isethionate, Sodium Olefin Sulphonate, and combinations thereof.

The cleaning composition will usually contain from about 5% to about 40% by weight of anionic surfactant. In certain embodiments, the cleaning composition contains about 7% to about 35% by weight of anionic surfactant. In some preferred embodiments, the cleaning compositions contain about 10% to about 30% by weight of anionic surfactant.

The amount of anionic surfactant utilized may be dependent on the choice and amount of filler and the desired dissolution rate of a solid unit dose formed from the cleaning composition, as is discussed in further detail below.

Non-ionic surfactants are useful in the context of this invention to both improve the cleaning properties of the compositions, when used as a detergent, and to contribute to product stability. A wide range of non-ionic surfactants can be used herein. For example, the non-ionic surfactants include, but are not limited to alkoxylated alcohols, polyoxyalkylene alkyl ethers, polyoxyalkylene alkylphenyl ethers, polyoxyalkylene sorbitan fatty acid esters, polyoxyalkylene sorbitol fatty acid esters, polyalkylene glycol fatty acid esters, alkyl polyalkylene glycol fatty acid esters, polyoxyethylene polyoxypropylene alkyl ethers, polyoxyalkylene castor oils, polyoxyalkylene alkylamines, glycerol fatty acid esters, alkylglucosamides, alkylglucosides, alkylamine oxides, or a combination thereof. Preferably, the nonionic surfactant is a glucamide in aqueous-alcoholic solution, such as Capryloyl/Caproyl Methyl Glucamide.

If included in the cleaning compositions, the amount of NI is typically about 1 weight percent to about 20 weight percent based on the total weight of the cleaning composition. Preferably, the NI is at least about 1.5 weight percent, most preferably about 1.5 to about 15 weight percent based on total weight of the cleaning composition.

When included therein the cleaning composition will usually contain from about from about 1% to about 40% by weight of a cationic surfactant, for example from about 0.5% to about 30%, in particular from about 1% to about 20%, from about 3% to about 10%, such as from about 3% to about 5%, from about 8% to about 12% or from about 10% to about 12%. Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, and combinations thereof.

The cleaning composition may contain from about 0% to about 40% by weight of a semipolar surfactant. Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, and combinations thereof.

The cleaning composition may contain from about 0% to about 40% by weight of a zwitterionic surfactant. Non-limiting examples of zwitterionic surfactants include betaines such as alkyldimethylbetaines, sulfobetaines, and combinations thereof.

Filler

The cleaning composition contains one or more fillers preferably selected from water-soluble salts, sugars and/or clays.

The filler can be, for example, a water-soluble inorganic alkali metal salt, a water-soluble organic alkali metal salt, a water-soluble inorganic alkaline earth metal salt, a water-soluble organic alkaline earth metal salt, a water-soluble carbohydrate, a water-soluble silicate, a water-soluble urea, or any combination thereof.

The filler can be, for example, sodium chloride, potassium chloride, calcium chloride, magnesium chloride, sodium sulfate, potassium sulfate, magnesium sulfate, sodium carbonate, potassium carbonate, sodium hydrogen carbonate, potassium hydrogen carbonate, sodium acetate, potassium acetate, sodium citrate, potassium citrate, sodium tartrate, potassium tartrate, potassium sodium tartrate, calcium lactate.

A sugar filler may also be use. In the present context, sugar fillers refer to saccharide containing components commonly known in the art, such as sucrose, dextrose, maltose, saccharose, lactose, sorbose, dextrin, trehalose, D-tagatose, dried invert sugar, fructose, levulose, galactose, corn syrup solids, and the like, alone or in combination.

The filler can be, for example, dextrose, fructose, galactose, isoglucose, glucose, sucrose, raffinose, isomalt, xylitol, or any combination thereof.

In certain embodiments, the filler consists essentially of a clay, a sugar, or a salt, and combinations thereof. In some of those embodiments, the filler consists essentially of a clay. In other of those embodiments, the filler consists essentially of a salt In yet other of those embodiments, the filler consists essentially of a sugar.

In some embodiments, the filler consists of a clay, a sugar, or a salt, and combinations thereof. In some of those embodiments, the filler consists of a clay. In other of those embodiments, the filler consists of a salt. In yet other of those embodiments, the filler consists of a sugar.

In one embodiment, the carrier or water-soluble carrier is sodium chloride.

In one embodiment, the carrier or water-soluble carrier is table salt.

In some embodiments, the filler is or includes a clay. In one embodiment, the clay is a smectite clay, e.g., a Bentonite clay, Beidellite clay, a Hectorite clay, a Laponite clay, a Montmorillonite clay, a Nontronite clay, a Saponite clay, a Sauconite, clay, or any combination thereof.

In one embodiment, the clay is a Bentonite clay.

In certain embodiments, the filler comprises, consists essentially of, or consists entirely of abrasive particles. The other components of the cleaning composition can act as a binder and carrier to secure the abrasive particles until they are exposed to a solvent. For instance, the water-soluble binder may be a surfactant. Additionally, the water-soluble binder may include a combination of various water-soluble binders, one of which may be a surfactant. Also, the water-soluble binder may include a combination of various surfactants. A surfactant is preferable because it provides additional cleaning capabilities to the cleaning composition.

The solvent begins dissolving the binder and other components and the abrasive particles release from the cleaning composition. By including abrasive particles, the cleaning composition provides for both scouring and cleaning of a surface.

The abrasive particles include the abrasive materials as well as combinations and agglomerates of such materials. In applications where aggressive scouring or other end uses are not contemplated or desired, softer abrasive particles (e.g., those having a Mohs' hardness in the range between 1 and 7) can be used to provide the head 30 with a mildly abrasive surface. Harder abrasive materials (e.g., having a Mohs' hardness greater than about 8) can also be included within the abrasive cleaning article of the invention to provide a finished article having a more aggressive abrasive surface.

The cleaning composition includes about 10% by about 80% by weight of filler/abrasive particles, more preferably about 40% to about 70% by weight.

In certain embodiments, the ratio of surfactant to filler is from 1:6 to 5:1. In preferred embodiments, the ratio of surfactant to filler is from about 1:4 to about 4:1.

In certain preferred embodiments, the ratio of surfactant to filler is about 1:1.5 to about 1:4.

In some preferred embodiments, the ratio of surfactant to filler is about 1:1.5.

Carbonate or Bicarbonate Salt

Examples of carbonate or bicarbonate salts suitable for use in illustrative embodiments include, but are not limited to, the alkali metal salts. Sodium carbonate, calcium carbonate, magnesium carbonate, ammonium carbonate, potassium carbonate, sodium bicarbonate, and calcium bicarbonate may all be employed.

The carbonate or bicarbonate salt may in conjunction with the selected filler provide the cleaning composition with the aforementioned abrasive particles.

The carbonate or bicarbonate salts may be added in an amount of about 1% to about 30% by weight of the composition, more preferably about 5% to about 25% by weight of the composition, most preferably about 10% to about 20% by weight of the composition.

Acid

Examples of acids suitable for use the cleaning compositions include, but are not limited to, tartaric acid, citric acid, fumaric acid, adipic acid, malic acid, oxalic acid, or sulfamic acid, either alone or in combination. Typically, the compositions are prepared from citric acid or a combination of citric acid and glycolic acid.

The acid comprises about 1% to about 30% by weight of the cleaning composition. In some embodiments, the acid comprises at least 5% by weight of the composition. In other embodiments, the acid comprises about 1% to about 7% by weight of the composition. In yet other embodiments, the acid comprises about 5% to about 30% by weight of the cleaning composition.

The acid and carbonate or bicarbonate salt may result in the composition being effervescent. In certain embodiments, the presence of bubbles results from the formation of carbon dioxide. For instance, when added to a liquid, such as water, a mixture of at least one acid and at least one carbonate or bicarbonate salt results in a chemical reaction that liberates carbon dioxide. In one aspect, both the acid and the salt may be in anhydrous form.

The term “effervescent,” as defined herein, means any product capable of forming bubbles in liquid environments and may also be considered any product capable of liberating carbon dioxide in or out of liquid environments. Likewise, “effervescence” means forming bubbles in liquid environments or liberating carbon dioxide in or out of liquid environments.

Color

The cleaning composition may further include a colorant. The colorant may be oil- or water-soluble, and typically is an anhydrous powder dye. The amount of colorant to be used may depend on the color intensity desired and the cost of the dye, and may be added at levels up to about 2.5% by weight of the cleaning composition.

The choice of the colorant will depend largely on the color desired for the water into which the cleaning compositions is to be dispensed. Examples of suitable water-soluble colorants include, but are not limited to, acid blue #9, Basacid Blue NB 755®, FD&C yellow #5, FD&C Red #33, and D&C Green #8. Oil-soluble colorants include, but are not limited to, Nitro Fast Red A 4B®, solvent yellow 72, Sandoplast Green G® and Unicert Blue.

Fragrance

In certain embodiments, the cleaning compositions include fragrance and/or perfume. In some of these embodiments, the fragrance may be released into the atmosphere through the formation of carbon dioxide. The fragrance is typically present in an amount of up to about 6% by weight of the cleaning composition.

The fragrance may be an oil fragrance, an essential oil, botanical extracts, synthetic fragrance materials, or other compounds that provide a desirable odor.

In some embodiments, a fragrance oil can be, for example, essential oils such as angelica root oil, anise oil, arnica blossom oil, basil oil, bay oil, champaca blossom oil, citrus oil, silver fir oil, silver fir cone oil, elemi oil, eucalyptus oil, fennel oil, pine needle oil, galbanum oil, geranium oil, ginger grass oil, guaiac wood oil, gurjun balsam oil, helichrysum oil, ho oil, ginger oil, iris oil, jasmine oil, cajeput oil, calamus oil, chamomile oil, camphor oil, canaga oil, cardamom oil, cassia oil, pine needle oil, copaiba balsam oil, coriander oil, spearmint oil, caraway oil, cumin oil, labdanum oil, lavender oil, lemongrass oil, lime blossom oil, lime oil, mandarin oil, balm oil, mint oil, musk seed oil, muscatel oil, myrrh oil, clove oil, neroli oil, niaouli oil, olibanum oil, orange blossom oil, orange oil, origanum oil, palmarosa oil, patchouli oil, peru balsam oil, petitgrain oil, pepper oil, peppermint oil, pimento oil, pine oil, rose oil, rosemary oil, sage oil, sandalwood oil, celery oil, spike oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil and ambrettolide, ambroxan, alpha-amylcinnamaldehyde, anethol, anisaldehyde, anise alcohol, anisol, anthranilic acid methyl ester, acetophenone, benzyl acetone, benzaldehyde, benzoic acid ethyl ester, benzophenone, benzyl alcohol, benzyl acetate, benzyl benzoate, benzyl formate, benzyl valerianate, borneol, bornyl acetate, boisambrene forte, alpha-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptine carboxylic acid methyl ester, heptaldehyde, hydroquinone dimethyl ether, hydroxycinnamaldehyde, hydroxycinnamyl alcohol, indol, irone, isoeugenol, isoeugenol methyl ether, isosafrole, jasmone, camphor, carvacrol, carvone, p-cresol methyl ether, cumarin, p-methoxyacetophenone, methyl n-amyl ketone, methyl anthranilic acid methyl ester, p-methyl acetophenone, methyl chavicol, p-methyl quinoline, methyl beta-naphthyl ketone, methyl n-nonyl acetaldehyde, methyl n-nonyl ketone, muscone, beta-naphthol ethyl ether, beta-naphthol methyl ether, nerol, n-nonyl aldehyde, nonyl alcohol, n-octyl aldehyde, p-oxy-acetophenone, pentadecanolide, beta-phenyl ethyl alcohol, phenyl acetic acid, pulegone, safrole, salicylic acid isoamyl ester, salicylic acid methyl ester, salicylic acid hexyl ester, salicylic acid cyclohexyl ester, santalol, sandelice, skatole, terpineol, thymene, thymol, troenan, gamma-undelactone, vanillin, veratrum aldehyde, cinnmaldehyde, cinnamyl alcohol, cinnamic acid, cinnamic acid ethyl ester, cinnamic acid benzyl ester, diphenyl oxide, limonene, linalool, linalyl acetate and propionate, melusat, menthol, menthone, methyl n-heptenone pinene, phenyl acetaldehyde, terpinyl acetate, citral, citronellal, and mixtures thereof.

In some embodiments, the fragrance can be an ester, an ether, an aldehyde, a ketone, an alcohol, a hydrocarbon, an essential oil, and a combination thereof.

In some embodiments, the fragrance can be, for example, adoxal (2,6,10-trimethyl-9-undecenal), anisaldehyde (4-methoxybenzaldehyde), cymal (3-(4-isopropyl-phenyl)-2-methylpropanal), ethylvanillin, florhydral (3-(3-isopropylphenyl)butanal), helional (3-(3,4-methylenedioxyphenyl)-2-methylpropanal), heliotropin, hydroxycitronellal, lauraldehyde, lyral (3- and 4-(4-hydroxy-4-methylpentyl)-3-cyclohexene-1-carboxaldehyde), methyl nonyl acetaldehyde, lilial (3-(4-tert-butylphenyl)-2-methylpropanal), phenyl acetaldehyde, undecylenaldehyde, vanillin, 2,6,10-trimethyl-9-undecenal, 3-dodecen-1-al, alpha-n-amylcinnamaldehyde, melonal (2,6-dimethyl-5-heptenal), 2,4-dimethyl-3-cyclohexene-1-carboxaldehyde (triplal), 4-methoxybenzaldehyde, benzaldehyde, 3-(4-tert-butylphenyl)propanal, 2-methyl-3-(paramethoxyphenyl) propanal, 2-methyl-4-(2,6,6-timethyl-2(1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl)propanal, 1-decanal, 2,6-dimethyl-5-heptenal, 4-(tricyclo[5.2.1.0(2,6)]decylidene-8)butanal, octahydro-4,7-methano-Hindenecarboxaldehyde, 3-ethoxy-4-hydroxybenzaldehyde, para-ethyl-alpha,alphadimethylhydrocinnamaldehyde, alpha-methyl-3,4-(methylenedioxy)hydrocinnamaldehyde, 3,4-ethylenedioxybenzaldehyde, alphan-hexylcinnamaldehyde, m-cymene-7-carboxaldehyde, alpha-methyl phenylacetaldehyde, 7-hydroxy-3,7-dimethyloctanal, undecanal, 2,4,6-trimethyl-3-cyclohexene-l-carboxaldehyde, 4-(3)(4-methyl-3-pentenyl)-3-cyclohexenecarboxaldehyde, 1-dodecanal, 2,4-dimethylcycl ohexene-3-carboxaldehyde, 4-(4-hydroxy-4-methylpentyl)-3-cylohexene-1-carboxaldehyde, 7-methoxy-3,7-dimethyloctan-1-al, 2-methylundecanal, 2-methyldecanal, 1-nonanal, 1-octanal, 2,6,10-trimethyl-5,9-undecadienal, 2-methyl-3-(4-tertbutyl) propanal, dihydrocinnamaldehyde, 1-methyl-4-(4-methyl -3-pentenyl)-3-cyclohexene-1-carboxaldehyde, 5- or 6-methoxyhexahydro-4,7-methanoindane-1- or -2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3J-dimethyloctanal, trans-4-decenal, 2,6-nonadienal, para-tolylacetaldehyde, 4-methylphenylacetaldehyde, 2-methyl -4-(2,6,6-trimethyl-1-cyclohexen-1-yl)-2-butenal, ortho-methoxycinnamaldehyde, 3,5,6-trimethyl-3-cyclohexene-carboxaldehyde, 3J-dimethyl-2-methylene-6-octenal, phenoxyacetaldehyde, 5,9-dimethyl-4,8-decadienal, peony aldehyde (6,10-dimethyl-3-oxa-5 ,9-undecadien-1-al), hexahydro-4,7-methanoindane-1-carboxaldehyde, 2-methyloctanal, alpha-methyl-4-(1-methylethyl)benzene acetaldehyde, 6,6-dimethyl-2-norpinene-2-propionaldehyde, paramethylphenoxyacetaldehyde, 2-methyl-3-phenyl-2-propen-1-al, 3,5,5-trimethylhexanal, hexahydro-8,8-dimethyl-2-naphthaldehyde, 3-propyl-bicyclo-[2.2.1]-hept-5-ene-2-carbaldehyde, 9-decenal, 3-methyl-5-phenyl-1-pentanal, methyl nonyl acetaldehyde, hexanal and trans-2-hexenal.

In some embodiments, the fragrance can be, for example, methyl betanaphthyl ketone, musk indanone (1,2,3,5,6,7-hexahydro-1,1,2,3,3-pentamethyl-4H-inden-4-one), tonalide (6-acetyl-1,1,2,4,4,7-hexamethyltetralin), alphadamascone, beta-damascone, delta-damascone, iso-damascone, damascenone, methyl dihydrojasmonate, menthone, carvone, camphor, koavone (3,4,5,6,6-pentamethylhept-3-en-2-one), fenchone, alpha-ionone, beta-ionone, gammamethyl ionone, fleuramone (2-heptylcyclopentanone), dihydrojasmone, cisjasmone, Iso E Super (1-(1,2,3,4,5,6J,8-octahydro-2,3,8,8-tetramethyl-2-naphthalenyl)ethan-1-one (and isomers)), methyl cedrenyl ketone, acetophenone, methyl acetophenone, para-methoxyacetophenone, methyl beta-naphtyl ketone, benzyl acetone, benzophenone, para-hydroxyphenylbutanone, celery ketone (3-methyl-5-propyl-2-cyclohexenone), 6-isopropyldecahydro-2-naphtone, dimethyl octenone, frescomenthe (2-butan-2-ylcyclohexan-1-one), 4-(1-ethoxyvinyl)-3,3,5,5-tetramethylcyclohexanone, methyl heptenone, 2-(2-(4-methyl-3-cyclohexen-1-yl)propyl)cyclopentanone, 1-(p-menthen-6(2)yl)-1-propanone, 4-(4-hydroxy-3-methoxyphenyl)-2-butanone, 2-acetyl-3,3-dimethylnorbornane, 6,7-dihydro-1,1,2,3,3-pentamethyl-4(5H)indanone, 4-damascol, dulcinyl(4-(1,3-benzodioxol -5-yl)butan-2-one), Hexalon (1-(2,6,6-trimethyl-2-cyclohexen-1-yl)-1,6-heptadien-3-one), isocyclemone E (2-acetonaphthone-1,2,3,4,5,6,7,8-octahydro-2,3,8,8-tetramethyl), methyl nonyl ketone, methyl cyclocitrone, methyl lavender ketone, orivone (4-tert-amylcyclohexanone), 4-tert-butylcyclohexanone, delphone (2-pentyl cyclopentanone), muscone (CAS 541-91-3), neobutenone (1-(5,5-dimethyl-1-cyclohexenyl)pent-4-en-1-one), plicatone (CAS 41724-19-0), veloutone (2,2,5-trimethyl-5-pentylcyclopentan-1-one), 2,4,4,7-tetramethyloct-6-en-3-one and tetrameran (6,10-dimethylundecen-2-one).

In some embodiments, the fragrance can be, for example, 10-undecen-1-ol, 2,6-dimethylheptan-2-ol, 2-methylbutanol, 2-methylpentanol, 2-henoxyethanol, 2-phenylpropanol, 2-tert-butylcyclohexanol, 3,5,5-trimethylcyclohexanol, 3-hexanol, 3-methyl-5-phenylpentanol, 3-octanol, 3-phenylpropanol, 4-heptenol, 4-isopropylcyclohexanol, 4-tert-butylcyclohexanol, 6,8-dimethyl-2-nonanol, 6-nonen-1-ol, 9-decen-l-ol, α-methylbenzyl alcohol, α-terpineol, amyl salicylate, benzyl alcohol, benzyl salicylate, β-terpineol, butyl salicylate, citronellol, cyclohexyl salicylate, decanol, dihydromyrcenol, dimethyl benzyl carbinol, dimethyl heptanol, dimethyl octanol, ethyl salicylate, ethyl vanillin, eugenol, farnesol, geraniol, heptanol, hexyl salicylate, isoborneol, isoeugenol, isopulegol, linalool, menthol, myrtenol, n-hexanol, nerol, nonanol, octanol, p-menthan-7-ol, phenylethyl alcohol, phenol, phenyl salicylat, tetrahydrogeraniol, tetrahydrolinalool, thymol, trans-2-cis-6-nonadicnol, trans-2-nonen-1-ol, trans-2-octenol, undecanol, vanillin, champiniol, hexenol and cinnamyl alcohol.

In some embodiments, the fragrance can be, for example, for example, benzyl acetate, phenoxyethyl isobutyrate, p-tert-butylcyclohexyl acetate, linalyl acetate, dimethyl benzyl carbinyl acetate (DMBCA), phenyl ethyl acetate, benzyl acetate, ethylmethylphenyl glycinate, allyl cyclohexyl propionate, styralyl propionate, benzyl salicylate, cyclohexyl salicylate, floramat, melusat and jasmacyclat.

In one embodiment, the fragrance can be, for example, for example, benzyl ethyl ether and ambroxan. The hydrocarbons include mainly terpenes, such as limonene and pinene.

In some embodiments, the fragrance is, for example, a musky scent, a pungent scent, a camphoraceous scent, an ethereal scent, a floral scent, a fruity scent, a peppermint scent, an aromatic scent, a gourmand scent, or any combination thereof.

In some embodiments, the fragrance can be mixtures of various fragrances, which can be referred to as a perfume or perfume oil. Perfume oils of this kind may also contain natural fragrance mixtures, as are obtainable from plant sources.

In some embodiments, the fragrance can be a fragrance precursor. “Fragrance precursor” refers to compounds which only release the actual fragrance following chemical conversion/separation, for example, when exposed to light or other environmental conditions, such as pH, temperature, etc. Treatment agents of this kind are often referred to as pro-fragrances.

Other fragrances known in the art, or any fragrance commercially available from a fragrance supplier (e.g. Firmenich, Givaudan, IFF, Symrise, Agilex, The Good Scents Company, Atlanta, Ga.)

Other fragrances and/or perfumes useful in the practice of the invention include the fragrances commonly used in the household and industrial cleaning and sanitizing industry.

As those of skill will appreciate, fragrances typically comprise highly concentrated solid ingredients. The presence of a non-hygroscopic solvent may be necessary to dissolve, disperse or mix these solid ingredients to make the fragrance homogenous throughout the solid cleaning head. Since fragrance manufacturers often incorporate solvents directly into their fragrances, coordinating solvent selection with the fragrance manufacturer may be necessary.

In some embodiments, the fragrance is, for example, present in the cleaning composition in an amount of about 0.5 wt. %, about 1.0 wt. %, about 1.5 wt. %, about 2.0 wt. %, about 3.0 wt. %, about 4.0 wt. %, or about 5.0 wt. %. In some embodiments, the fragrance is, for example, present in an amount from about 0.1 wt. % to about 5 wt. %, from about 0.5 wt. % to about 4.5 wt. %, about 0.5 wt. % to about 4 wt. %, from about 1.0 wt. % to about 4 wt. %, or from about 1.5 wt. % to about 4 wt. %.

Other Components:

The solid cleaning composition can comprise other customary additives such as binders to hold the different components in the system together, disintegrants to hold the composition together when dry and break the tablet quickly once being exposed to water, tableting aids to ease the compression process and so on.

Binder

The cleaning composition can include water-soluble binder. Those having a having a weight average molecular weight less than 200,000 will typically be more readily soluble in water. Many water-soluble binders are known. The water-soluble binder may be oligomeric or polymeric, and may include copolymers and blends thereof. Nonlimiting examples of polymers and copolymers suitable for use as water-soluble binders include polyethylene glycol, polyvinylpyrrolidones, polyvinylpyrrolidone/vinyl acetate copolymers, polyvinyl alcohols, carboxymethyl celluloses, hydroxypropyl cellulose starches, polyethylene oxides, polyacrylamides, polyacrylic acids, cellulose ether polymers, polyethyl oxazolines, esters of polyethylene oxide, esters of polyethylene oxide and polypropylene oxide copolymers, urethanes of polyethylene oxide, and urethanes of polyethylene oxide and polypropylene oxide copolymers.

In one embodiment, a preferred binder is hydroxypropylmethylcellulose.

The binder may be present from 0% to 15% by weight of the composition, preferably from about 0% to about 10%, most preferably from 0% to about 5% by weight of the cleaning composition.

Lubricant

A lubricant may be used in the cleaning formulations. The lubricant should combine hydrophobic and hydrophilic properties in order to achieve both good lubrication and a short disintegration time. Surfactants such as sodium lauryl sulfate, fumaric acid, magnesium stearate and magnesium lauryl sulfate can be used. The lubricant may also be selected from wheat germ oil, canola oil, safflower oil, sunflower seed oil, sesame oil, cotton seed oil, corn oil, palm oil, coconut oil, flax seed oil, olive oil, mineral oil, PEG 200, PEG 300, PEG 400, and combinations thereof.

A lubricant can also be added when compressing the composition. For example, optionally prior to introduction of a preform into a die, one or more of the interior surfaces of the mold may be sprayed with a mold release material or other lubricant such as mineral oil or a paraffin oil.

The lubricant may be included up to 5% by weight of the composition, preferably less than about 1% by weight, more preferably about 0.5% by weight or less of the composition.

Glidant

A glidant may be included in the composition to promote the flow properties of tablet granules or powder materials.

Examples of glidants that may be used include colloidal silicon dioxide, talc, tribasic calcium phosphate, hydrophobic colloidal silica, hydrophobic fumed silica, cellulose, magnesium oxide, sodium stearate, magnesium silicate, and magnesium trisilicate.

When included, the glidant is typically present at less than 5% by weight of the composition, more preferably about 2% by weight or less, most preferably less than 1% by weight.

Methods of Use

To use the cleaning compositions to clean a surface, the composition is compressed e.g. into a tablet and the compressed unit is exposed to a solvent, typically water, which is capable of dissolving the water-soluble filler and surfactant. The cleaning composition may be submerged in water from a toilet, sink, or bathtub depending on the surface being cleaned.

Upon contact with the solvent, the water-soluble filler begins to dissolve. The surfactant provides the detergent for cleaning the surface. Any abrasive particles are also released onto the surface to be cleaned and provide the abrasive material for scouring the surface. The surfactant will foam when exposed to the solvent. The foam helps to suspend the released abrasive particle for prolonged use in scouring the surface.

The release of the abrasive particles assists in scouring the surface. However, because the abrasive particles are not rigidly adhered to any component, the abrasive particles are allowed to roll during cleaning, which prevents excessive scratching and damage to the surface.

Upon continual exposure to the solvent, a majority of the water-soluble filler is dissolved, and therefore a majority of abrasive particles are exposed to the surface.

Therefore, upon completion of the cleaning, the user may flush the composition down the toilet.

Method of Preparation

The solid compositions described herein can be manufactured in by various methods including direct compression, wet granulation, or dry granulation followed by compression. Alternatively, solids can be formed by an extrusion process.

In one embodiment, the method of manufacture may comprise grinding all powder materials to a fine particle size using a mortar and pestle or by passing through a sieve; melting ingredients, such as nonionic surfactant, to around 80° C. and combining all the materials until uniform. The resulting mixture is them pressed into tablets.

In another embodiment, powder ingredients can be combined in a v-blender or with a mixer and directly compressed into a tablet.

In yet another embodiment, an acid premix and a basic premix may be prepared and sieved or ground to a fine particle size. The two mixtures can each be wet granulated and dried in an oven. The dried granules are blended together with any extragranular glidant and/or lubricant. The final mixture is compressed into tablets.

In a further embodiment, the method of manufacture may comprise extruding the treatment composition and cutting into pucks. The extrusion process may be a co-extrusion process and the head has at least two distinct portions having different compositions. The method may include a step of wrapping the head in a water soluble film.

Typically, the unit dose is manufactured by compression on conventional tablet press using round or oval convex or flat face tooling. In preferred embodiments, the tooling is designed such that the compressed solid contains an indentation in one of its surfaces that can be adapted to receive a wand. The depth of the indentation Yc-Yd is less than the height Ya-Yb. In one embodiment, the compressed solid can comprise an annular shape with a cylindrical socket 36 in its center that extends either partially or entirely through the height of the compressed solid, whereby the compressed solid can be mounted on a pin 28 extending from wand 20.

The depth of the indentation may be anywhere from 25% to 100% of the height of the compressed solid.

Weights of tablets: the tablets will typically weigh about 1 to about 70 grams, more preferably about 10 to about 50 grams, most preferably 20 to about 40 grams. In certain embodiments, a tablet weighs about 2 to 3 grams, more preferably 2.25 to 2.5 g.

Hardness: A tablet strength above 15 N is acceptable, more preferably the tablet hardness is over 20 N, most preferably to over 30 N.

### EXAMPLES

### Example 1: Tablet Compositions

Composition. Composition 1 is representative of a Fragrance Free formula whereas Composition 2 includes a Fragrance.

| Ingredient | Activity | Composition 1 | Composition 2 |
|---|---|---|---|
| Alpha olefin sulfate, | 90 | 15% | 14.50% |
| sodium salt | | | |
| Sodium Cocoyl Isethionate | 85 | 15% | 14.50% |
| Sodium Bicarbonate | | 20% | 20% |
| Oxalic Acid | | 15% | 14.50% |
| Citric Acid | | 15% | 14.50% |
| Bentonite Clay | 100 | 10% | 10% |
| Capryloyl/Caproyl Methyl | 100 | 10% | 10% |
| Glucamide | | | |
| Dye (Unicert Blue) | | 0.10% | 0.10% |
| Fragrance | | — | 2% |

Tablet Preparation

Compositions were compressed into tablets with the following procedure: Pre-melt nonionic surfactant to 80° C.; Grind all powder materials to a fine particle size (in a mortar and pestle); Combine all ingredients and mix materials until uniform; Press powder into tablets.

Dissolution

Dissolution rates of Compositions 1 and 2 were observed by dropping approximately 2.27 to 2.45 grams of Composition 1 or 2 into Tap Water (no agitation). Composition 1 was completely dissolved after 16 minutes and Composition 2 after 25 minutes, for a dissolution rate of 0.15 g/min and 0.09 g/min, respectively.

This observation displayed the feasibility of creating a compressed powder that can dissolve without agitation in the toilet bowl (i.e. if the consumer cleaned the toilet and then dropped the compressed puck in the bowl afterwards).

### Example 2: Study on Ratio of Surfactant to Filler

Various ratios of Bentonite Clay to anionic powder surfactant were tested for structural integrity and solubility.

Composition

| Surfactant: bentonite % | 100:0 | 80:20 | 60:40 | 40:60 | 20:80 | 0:100 |
|---|---|---|---|---|---|---|
| Ingredient/Composition No. | 3 | 4 | 5 | 6 | 7 | 8 |
| Sodium Cocoyl Isethionate 85% | 71 | 56.8 | 42.6 | 28.4 | 14.2 | 0 |
| Bentonite Clay | 0 | 14.2 | 28.4 | 42.6 | 56.8 | 71 |
| Sodium Bicarbonate | 10 | 10 | 10 | 10 | 10 | 10 |
| Citric Acid | 15 | 15 | 15 | 15 | 15 | 15 |
| Hydrophobic Fumed Silica | 2 | 2 | 2 | 2 | 2 | 2 |
| Hypromellose 100 cPs | 2 | 2 | 2 | 2 | 2 | 2 |
| Total Weight | 100 | 100 | 100 | 100 | 100 | 100 |

Tablet Preparation

Tablets were prepared by direct compression. All materials were combined in a glass jar and then rolled on a standard jar mill for 12 minutes. The blend was compressed at 1.6 MT into a tablet.

To determine solubility, the tablet is first weighed (initial weight), then submerged in water for the desired time (1 or 5 minutes), then the tablet is removed, dried for 12 hours and then weighed (final weight). The % dissolved is calculated by taking [initial weight minus final weight] divided by initial weight.

Height of the tablet was measured with a standard caliper after removal from tablet press.

Tablet Properties

| | Height | Strength | 5 min dissolution |
|---|---|---|---|
| Composition | (cm) | (N) | (%) |
| 3 | 1 | 155 | 2.64 |
| 4 | 0.9 | 137 | 3.98 |
| 5 | 0.9 | 121 | 3.60 |
| 6 | 0.8 | 76 | 9.19 |
| 7 | 0.8 | 32 | 22.30 |
| 8 | 0.8 | 15 | 13.49 |

High surfactant formulations, such as Compositions 3 to 6, may clean and perform superior, but may be cost prohibitive for a commercial application.

### Example 3: Effect of Filler on Dissolution

Tablets having various fillers were prepared with the following Compositions 9-11.

| | Comp. | | |
|---|---|---|---|
| Ingredient | 9 | 10 | 11 |
| Bentonite Clay | 0 | 0 | 42.48 |
| NaCl | 0 | 42.48 | 0 |
| Sucrose | 42.48 | 0 | 0 |
| Citric Acid | 14.75 | 14.75 | 14.75 |
| HPMC, 100 cPs | 3.77 | 3.77 | 3.77 |
| Sodium Cocoyl Isethionate 85% | 28.4 | 28.4 | 28.4 |
| Sodium Bicarbonate | 9.6 | 9.6 | 9.6 |
| Hydrophobic Fumed Silica | 0.5 | 0.5 | 0.5 |
| Magnesium Stearate | 0.5 | 0.5 | 0.5 |

Method of Preparation

Combine ingredients into two premixes: acid and basic; mix separately until uniform.

a. Acid Premix:
i. Bentonite
ii. Salt
iii. Citric Acid
iv. Approximately half of HPMC

b. Basic Premix:
i. Anionic Surfactant
ii. Sodium Bicarbonate
iii. Approximately half of HPMC
   Add a 10% Ethanol in DI Water solution to separate premixes until powder lumps together. Grind all powder materials to a fine particle size (in a mortar and pestle). Dry in Vacuum Oven for 1-2 hours. Combine Acid and Basic premixes together with Fumed Silica through dry blending. Add Magnesium Stearate to mixture and dry blend. Press powder into tablets using approximately 0.4 metric tons force. After formation of tablets, the tablet strength, dissolution rate, and height were measured

Tablet Properties

Dissolution was measured according to the method in Example 3.

Height of the tablet was measured with a standard caliper after removal from tablet press.

To determine tablet strength (or hardness), the tablet was placed in a Dr. Schleuniger Pharmatron Model 6D Tablet Tester. The machine's default setting then crushes the tablet and gives a Newton force hardness measure.

| | % Dissolved | % Dissolved | Height | Strength |
|---|---|---|---|---|
| | 1 minute | 5 min | (cm) | (N) |
| Comp. 9 | 13 | 24 | 9.8 | 13 |
| Comp. 10 | 67 | 94 | 8.5 | 15 |
| Comp. 11 | 4 | 22 | 9 | 15 |

Dissolution rates at 1 minute, which are indicative of how much cleaner will be release as the product is in use, showed sodium chloride with the highest rate (at 67% dissolved), versus 13% of sucrose and 4% of bentonite.

### Example 4: Effect of Filler on Compression

The following example was created using a direct compression method, which entails simple powder blending of all materials (in a single batch), without premixes or solvent; and then compressing at 1.6 MT into a tablet.

Composition

| | Comp. | | |
|---|---|---|---|
| Ingredient | 12 | 13 | 14 |
| Bentonite Clay | 0 | 0 | 58.88 |
| NaCl | 58.88 | 0 | 0 |
| Sucrose | 0 | 58.88 | 0 |
| Citric Acid | 14.75 | 14.75 | 14.75 |
| HPMC, 100 cPs | 3.77 | 3.77 | 3.77 |
| Sodium Cocoyl Isethionate 85% | 12.00 | 12.00 | 12.00 |
| Sodium Bicarbonate | 9.6 | 9.6 | 9.6 |
| Hydrophobic Fumed Silica | 0.5 | 0.5 | 0.5 |
| Magnesium Stearate | 0.5 | 0.5 | 0.5 |

After formation of tablets, the tablet strength, dissolution rate, and height were measured as in Examples 2 and 3.

Results

| | % Dissolved | Height | Strength |
|---|---|---|---|
| | 5 min | (cm) | (N) |
| Comp. 12 | 16 | 0.85 | 11 |
| Comp. 13 | 18 | 0.90 | 19 |
| Comp. 14 | 9 | 0.80 | 58 |

Sucrose and NaCl tablets had the most favorable dissolution, but had lower tablet strength vs. Bentonite-filled tablets. But the Bentonite tablet had ½ the dissolution rate as Sucrose and nearly half of NaCl.

By increasing the compression pressure from 0.4 MT to 1.6 MT, Composition 14 (Bentonite filler), had an increase in tablet strength; from 15 N with Composition 11 to 58 N in Composition 14. Sucrose increased its tablet strength slightly (from 13 N in Composition 9 to 19 N in Composition 13) and NaCl did not see a change.

It will be appreciated that, within the principles described by this specification, a vast number of variations exist. It should also be appreciated that the embodiments described are only embodiments, and are not intended to limit the scope, applicability, or construction of the claims in any way.

What is claimed is:

1. A solid unit dose toilet cleaning composition comprising
an anionic surfactant;
a carbonate or bicarbonate salt;
a water-soluble filler comprising a clay, a sugar, or a salt; and
an organic acid,
wherein the ratio of anionic surfactant to filler is 1:6 to 5:1.

2. The unit dose toilet cleaning composition of claim 1, wherein the water-soluble filler is about 10% to about 70% by weight of the cleaning composition.

3. The unit dose toilet cleaning composition of claim 1, wherein the filler comprises bentonite clay.

4. The unit dose toilet cleaning composition of claim 1, wherein the anionic surfactant is selected from Sodium Dodecylbenzenesulfonate, Sodium Cocoyl Isethionate, Sodium Olefin Sulphonate, and combinations thereof.

5. The unit dose toilet cleaning composition of claim 1, wherein the organic acid comprises about 1% to about 30% by weight of the cleaning composition.

6. The unit dose toilet cleaning composition of claim 1, wherein the organic acid consists of glycolic acid or citric acid.

7. The unit dose toilet cleaning composition of claim 1, wherein the unit dose is a compressed solid.

8. The unit dose toilet cleaning composition of claim 7, wherein the unit dose has a dissolution rate of at least about 0.1 g/min minute when submerged in water without agitation.

9. The unit dose toilet cleaning composition of claim 1, wherein the unit dose weighs about 2 to about 3 grams.

10. A dissolvable toilet cleaning tablet comprising
an anionic surfactant;
a carbonate or bicarbonate salt;
filler; and
an organic acid,
wherein the tablet has a dissolution rate of at least about 0.1 g/minute when submerged in water without agitation.

11. The dissolvable toilet cleaning tablet of claim 10, wherein the ratio of anionic surfactant to filler is 1:6 to 5:1.

12. The dissolvable toilet cleaning tablet of claim 10, wherein the tablet has a hardness of at least 15 N.

13. The dissolvable toilet cleaning tablet of claim 10, wherein the tablet has height of about 0.5 cm to about 10 cm.

14. The dissolvable toilet cleaning tablet of claim 10, wherein the tablet has a hardness greater than 30 N.

15. The dissolvable toilet cleaning tablet of claim 10, wherein the tablet has a top surface, a bottom surface, and a height extending from the top surface to the bottom surface, the top surface having an indentation adapted to receive and engage with a wand member.

16. A kit comprising at least one dissolvable toilet cleaning tablet of claim 15 and a wand member.

17. A solid toilet cleaning composition comprising
about 5% to about 50% by weight anionic surfactant;
about 10% to about 80% by weight filler selected from clay, sugars, and water-soluble salts;
about 5-20% by weight of a carbonate or bicarbonate salt; and
about 1% to about 30% by weight of an organic acid,
wherein at least 12% by weight of the tablet dissolves after 5 minutes submerged in water.

18. The solid toilet cleaning composition of claim 17, wherein the ratio of anionic surfactant to filler is 1:6 to 5:1.

19. The solid toilet cleaning composition of claim 17, wherein the organic acid is selected from citric acid and/or glycolic acid.

20. The solid toilet cleaning composition of claim 17, wherein the solid weighs about 2 to about 3 grams.
